(19) United States
(12) Patent Application Publication
(10) Pub. No.: US 2005/0071065 A1
(43) Pub. Date: Mar. 31, 2005

(54) Method for controlling and/or regulating a starting process of a vehicle

(76) Inventors: Martin Zimmermann, Sasbach (DE); Johannes Moosheimer, Buehl (DE); Juergen Eich, Buehl (DE); Georg Schneider, Karlsruhe (DE); Alexander Schweizer, Walzbachtal-Joehlingen (DE); Martin Vornehm, Buehl (DE); Jesus Carl Guilliano Pereira, Campo Grande (BR)

Correspondence Address: Davidson Davidson & Kappel, 485 Seventh Avenue, 14th Floor, New York, NY, 10018, US

(21) Appl. No.: 10/489,567

(22) PCT Filed: Jul. 8, 2002
(86) PCT No.: PCT/DE02/02490

(30) Foreign Application Priority Data
Jul. 11, 2001 (DE) 101 33 698.5

(51) Int. Cl. G06F 7/00

(52) U.S. Cl. 701/51; 701/54

(57) ABSTRACT

A method for controlling a transmission of a vehicle, especially an automated transmission and/or an automated clutch. A starting characteristic curve is used to adjust a nominal torque of the clutch, the characteristic curve is modified in order to adapt to different operating states of the vehicle, in such a way that the desire of the driver is taken into account when the vehicle is brought into motion.

The present invention is directed to a method for controlling and/or regulating a vehicle transmission, in particular an automated shift transmission and/or an automatically operated clutch, where a driveaway characteristic curve is used to adjust a desired clutch torque.

An engine-speed control can be performed, for example, particularly during a driveaway operation of a vehicle having an automated shift transmission or an automatically operated clutch. In the process, as a function of the engine speed, a suitable coupling torque is set at the clutch on the basis of a driveaway characteristic curve. Preferably a so-called standard characteristic or a nominal driveaway characteristic curve can be used for the driveaway operation.

However, it turns out that the known method, which makes use of the nominal driveaway characteristic curve, does not sufficiently consider the intended driver input. Particularly in the context of different operating and/or driving conditions of the vehicle, such as full-load driveaway or part-load driveaway, the driveaway engine speed cannot be sufficiently changed. In addition, the known driveaway processes do not adequately consider whether the engine is warm or cold during the vehicle's transition to motion.

Moreover, it has been shown that, in the known methods for driving a transmission, during a driveaway operation on a hill or on an uphill gradient, due to inadequate consideration of the driveaway characteristic curve, there is the risk that the driver will attempt to keep the vehicle in an operating state only by increasing the accelerator-pedal angle. This can disadvantageously cause overheating of the clutch, thereby potentially damaging it.

The object of the present invention is to devise a method for controlling and/or regulating a transmission where the particular intended driver input and the prevailing operating conditions are sufficiently considered, especially during the driveaway operation.

This objective is achieved in accordance with the present invention by modifying the driveaway characteristic curve to enable adaptations to be made according to different operating conditions of the vehicle, in such a way that the driver input is considered when the vehicle is set in motion. In this manner, a method for controlling and/or regulating a transmission is devised, where the driveaway characteristic curve is adaptable to different operating conditions and also to the particular intended driver input.

In accordance with the invention presented here, it is especially beneficial that the driveaway characteristic curve is influenced, in particular, by at least one suitable factor, in order to improve the driveaway operation. For example, a time-dependent change in the factor may also be provided. It is thus possible for the specific intended input of the particular driver with regard to driveaway to be realized in the simplest possible manner using the driveaway characteristic curve or the driveaway function.

Another possible embodiment may provide for the factor to be weighted as a function of the accelerator pedal and/or the gear. Preferably, the factor may be approximated to an upper range value via the time function. It is possible, for example, for a linear function having a predefined slope, such as 1% per interrupt or the like, to be selected in the process. This means that the upper range value is reached approximately one second after the driveaway operation begins, a driveaway in first gear possibly being used as a basis, for example. A timing element may preferably be started at the value zero, as soon as the driver actuates the so-called low-idle-speed switch, in order to specify his/her intended driveaway input. It is also conceivable for the timing element to be preferably decremented by about 0.5% per interrupt upon actuation of the low-idle-speed switch, i.e., in the case of an interrupted driveaway operation, the driver does not accelerate. Thus, the weighting factor or factor may be increased from zero on at every driveaway operation, even given an only brief standstill, since, in neutral, the factor is reset to zero.

Typically, in a driveaway operation involving a kickdown, the driver is very quick to actuate the accelerator pedal. Since, however, the weighting factor and thus the clutch torque is first gradually increased, the engine is able to rotate past the driveaway speed, the engine speed being thereby first limited again by the clutch torque that builds up with a time delay. In this manner, a short-term increase in acceleration may be achieved using the driveaway characteristic curve provided by the present invention, for example for the kickdown driveaway operation. In the process, the driveaway function may be suitably adapted, so that the clutch is not overloaded.

In accordance with another embodiment of the present invention, during a transition from the normal driving condition to the kickdown operating condition, it is possible for the change to take place over a time ramp or the like, so that the curve of the desired clutch torque advantageously exhibits no sudden change. In this context, other time functions may also be used. During the transition to the kickdown operating state, the factor used may preferably be reduced.

It is also conceivable, particularly in the case of a high load, for the temperature of the clutch or the like to be considered, for example, as a parameter for determining the driveaway function, in order to protect the clutch. Other suitable parameters, such as engine and/or transmission variables, may also be considered.

In this way, the driveaway operation of a vehicle having an automatically operated clutch or an automated shift transmission is able to reflect to a greater degree the driver's active input, without having to accept any loss in the ruggedness of the system.

Another embodiment of the present invention provides, when necessary, for maximum engine speeds and maximum engine torques to be enabled by the driveaway strategy according to the present invention. This may be realized by the factor which is preferably dependent on the throttle valve-angle signal, i.e., the accelerator pedal-angle signal or the like, during a driveaway operation. In this manner, both the engine speed, as well as the engine torque may be increased, for example, at large throttle-valve angles, so that the driver input is considered.

Preferably, at least one suitable filter may be used, to prevent torque variations, particularly in response to rapid changes in the throttle valve angle, for example during the so-called tip-in operating state and the so-called back-out operating state. For example, two filters may be used, which have different timing elements during phases of positive and negative gradients of the throttle-valve characteristic curve.

In accordance with another embodiment of the present invention, a so-called first-order PT-I filter or the like may preferably be used. The filter may have an exponential timing element or the like, for example.

To avoid sharp torque fluctuations, a limitation of the gradient of the throttle-valve factor is conceivably provided, to ensure that the changes in the throttle-valve factor do not exceed a predefined limiting value. The driveaway strategy is able to be positively influenced by using the factor for the driveaway characteristic curve. The engine speed and the engine torque, in the same way as the energy flowing into the clutch, may be significantly increased during a full-load driveaway operation. Using this modified driveaway strategy in accordance with the method of the present invention, the power input may be advantageously increased during full-load driveaway operations, while in known driveaway strategies, on the other hand, the power input may be increased for all types of driveaway operations.

In the case of an automatically operated clutch, a clutch torque curve may be specified over the engine speed, for example, during a driveaway operation . The throttle valve-dependent factor may effect a multiplication of the driveaway characteristic curve, which is dependent on corresponding changes in the throttle-valve angle.

The driveaway characteristic curve may be advantageously modified by the factor at a predetermined section, so that it is suitably adapted by the variable factor to different operating states.

Within the framework of a next embodiment of the present invention, it is possible for the driver input to be considered in that a deviating realization of the accelerator-pedal dependency, i.e., throttle-valve dependency is avoided. To this end, clutch torque Mₖ may be determined by the following function:
Mₖ=driveaway characteristic curve (n_{engine}- k_{α}α)
Mₖ being=desired clutch torque
n_{engine}=engine speed
k_{α}·α=correction term and
αbeing=accelerator-pedal angle/throttle-valve angle.

The function of the driveaway characteristic curve, which is represented by the right side of the above equation, may be ascertained here by evaluating the nominal driveaway characteristic curve, preferably by using interpolation.

Accordingly, the argument of the characteristic evaluation may be corrected using accelerator-dependent term K_{α}*α. In this context, factor K_{α}preferably relates to a constant value, which may be selected, for example, to equal 10. Other values for factor K_{α}are also possible.

In this manner, the driveaway characteristic curve may be adapted to different operating conditions. It is possible for a rate-of-change limitation to be used for correction term Kα*α,in order to avoid an undesired clutch torque curve, for example in response to rapid accelerator pedal changes during the driveaway operation. By using the correction term, the driveaway characteristic curve may be suitably shifted towards the engine speed. Other suitable measures are also possible, in order to optimize the driveaway operation of the vehicle.

Such driveaway finctions having corresponding correction terms may be used, in particular, for automatically operated clutches in electronic clutch management (ECM) and/or for automated shift transmissions, as well as for CVT (continuously variable) transmissions.

Another embodiment of the present invention relates to the change in the driveaway characteristic curve, for example in response to an increased idling speed. The driveaway characteristic curve may be shifted, at least in stages, by the control of the electronic clutch management and/or by the control of the automated shift transmission, in particular as a function of the idling speed. In this way, the speed and/or the slip-sensitive torques in the clutch strategy are suitably changed, thereby allowing the driveaway speed to increase for a vehicle in a cold state, for example, and the slip to be reduced at a slower rate during gearshift operations. This shift may be necessary in the idling range, in order not to mistakenly attribute the increased speed to the driver.

Accordingly, the handling properties at an elevated idling speed, thus typically accompanied by a cold engine, may advantageously be adjusted to the warmed-up state of the vehicle.

For example, the driveaway characteristic curve may be shifted by the difference between the idling speed typical of a warm engine, and the current idling speed, toward higher engine speeds. In the process, the shift in the driveaway characteristic curve may decrease linearly with increasing engine speed, until the shift reaches a predefined engine speed. It is possible that the driveaway characteristic curves are identical for elevated idling speeds and for normal idling speeds when the engine speeds are higher than the predefined engine speed. It is also conceivable for the driveaway characteristic curve to be modified in other ways.

A next embodiment of the present invention relates to an improvement in the control, in particular of an automatically operated clutch, with respect to ride comfort and availability performance, preferably during driveaway operations on a hill.

To prevent the clutch from overheating, particularly during driveaway operations on a hill, a driving condition-dependent or operating condition-dependent closing function may be provided, for example. This enables the clutch to be closed at a predefined rate following a preset delay, for example. The availability performance of the system is thereby advantageously enhanced.

It is especially beneficial when this closing function is not activated in response to predefined driving situations, in order to advantageously enhance the ride comfort in these driving situations as well. For example, the closing function could be deactivated when engaging the reverse gear, to provide the driver with the same maneuvering convenience in difficult situations, in the reverse gear as well.

It could also be provided for the closing function to be modified in such a way that it is only activable in the reverse gear, for example above a predefined temperature threshold, for example 200° C., in order to thereby prevent a misuse of this function in unsuitable driving situations.

Yet another possibility in accordance with the present invention may provide for the closing function to be inhibited, for example, for a preset number of first driveaway situations during a driving cycle. The number N of the first driving situations may have a value of N=3, for example. Other values for the number N may also be used.

To implement the proposed measures, the following procedure may be used:
1. A counter is initialized at the beginning of the driving cycle with the value 0.
2. When it is recognized in a driveaway situation that the clutch slip after a certain time period, for example three seconds, has still not yet been reduced, the counter may be incremented.
3. When the counter has not yet exceeded a predefined counter reading, the closing function may remain inactive.
4. When the counter reading exceeds a predefined threshold value, the closing function may be activated.
5. The counter may preferably be incremented per driveaway operation where continuous slip is recognized, each time by the same amount, it also being possible for the counter to be incremented, for example, proportionally to the time duration of the clutch slip.

The aforementioned measures may be supplemented by other measures and also combined with one another in any desired manner.

Another embodiment of the present invention may provide for the clutch to be closed earlier and/or faster in the case that the gradient of the clutch temperature exceeds a certain value. For earlier and/or faster closing of the clutch, other suitable vehicle data may also be used. When the gradient of the clutch temperature is used for this purpose, it may be ascertained, for example, by measuring or.calculating the temperature of the clutch every ten seconds and comparing it to the value of the measurement or calculation of, for example, 10 seconds earlier. Other methods for calculating and comparing the clutch temperature are also possible.

The aforementioned measures of the present invention for improving the control of the automatically operated clutch or of the automated shift transmission may also be combined with one another in any desired fashion, in order to improve the driving, in particular, of a dry clutch during driveaway operations on a hill.

The method according to the present invention for controlling and/or regulating a transmission may be used for any system, in particular for automatically. operated clutches and/or for automated shift transmissions of every kind, calibrations being advantageously possible in order to optimally adapt the driveaway strategy to specific situations. Accordingly, the method of the present invention makes it possible for a driver's intended input to be sufficiently considered.

Other advantageous embodiments are derived from the dependent claims and from the drawings described in the following, whose figures show:

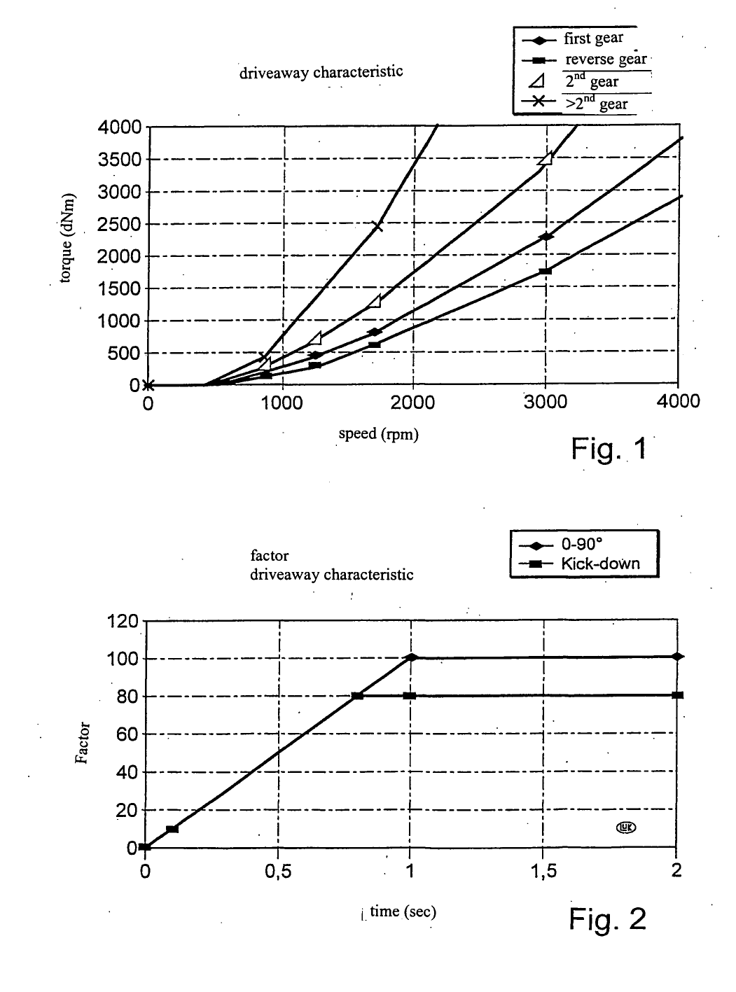

FIG. 1 various driveaway characteristic curves for different gears;

FIG. 2 two driveaway characteristic curves weighted with a time-dependent factor, at different operating states;

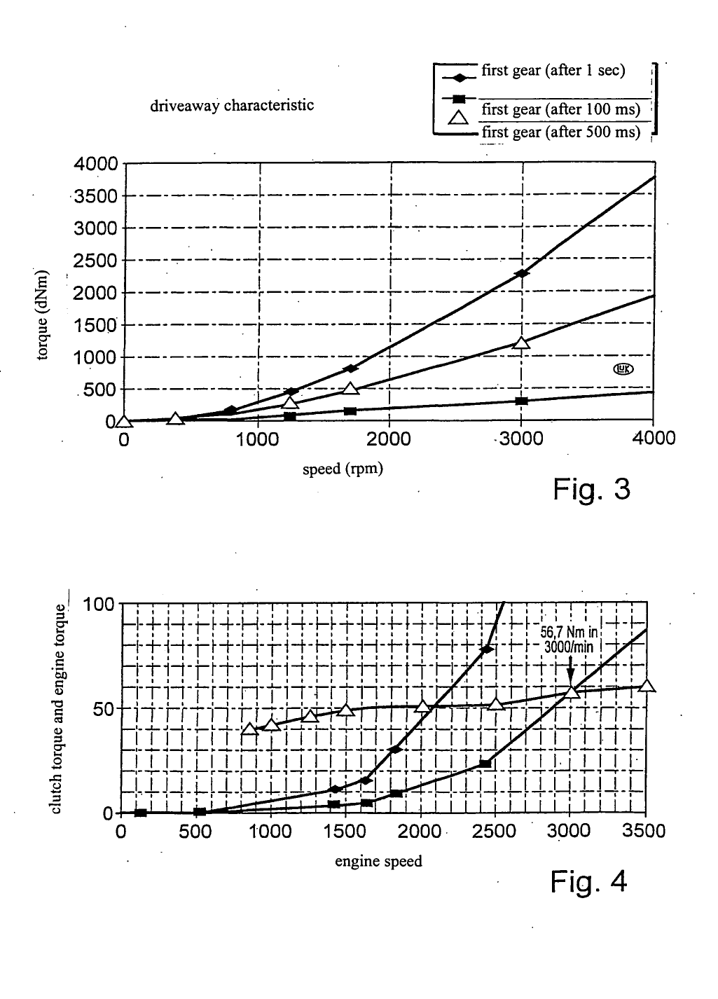

FIG. 3 a plurality of driveaway characteristic curves, the desired clutch torque being shown as a function of the engine speed and the time factor;

FIG. 4 three driveaway characteristic curves, an original curve (triangles) and two curves according to the present invention (rhombi and squares) being shown;

FIG. 5 a curve of the factor as a function of the throttle-valve angle;

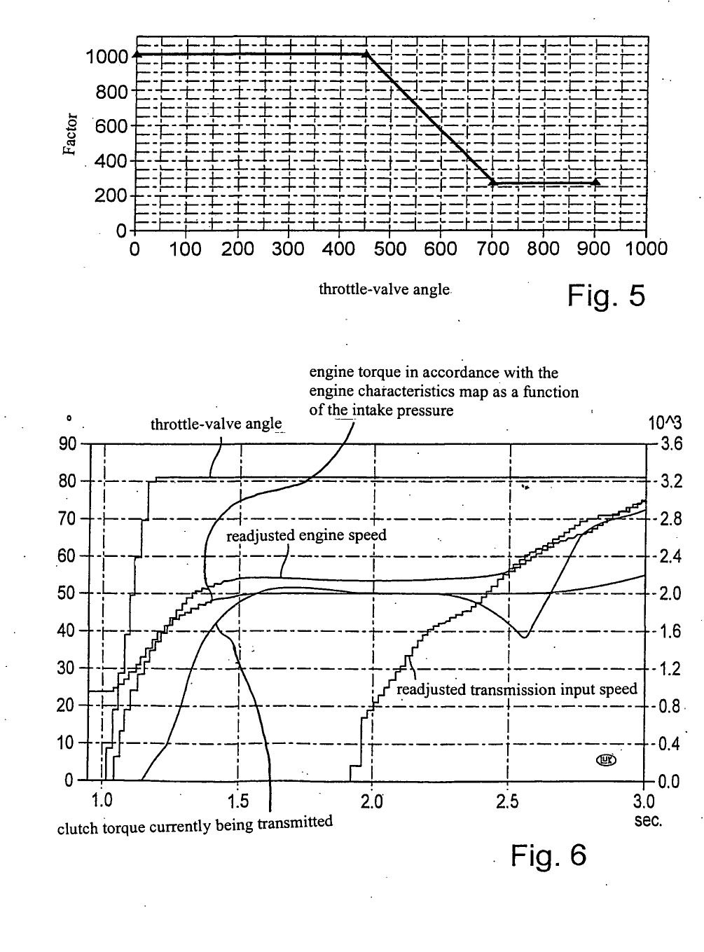

FIG. 6 a driveaway operation at full load;

FIG. 7 a driveaway operation at full load, in consideration of the factor according to the present invention;

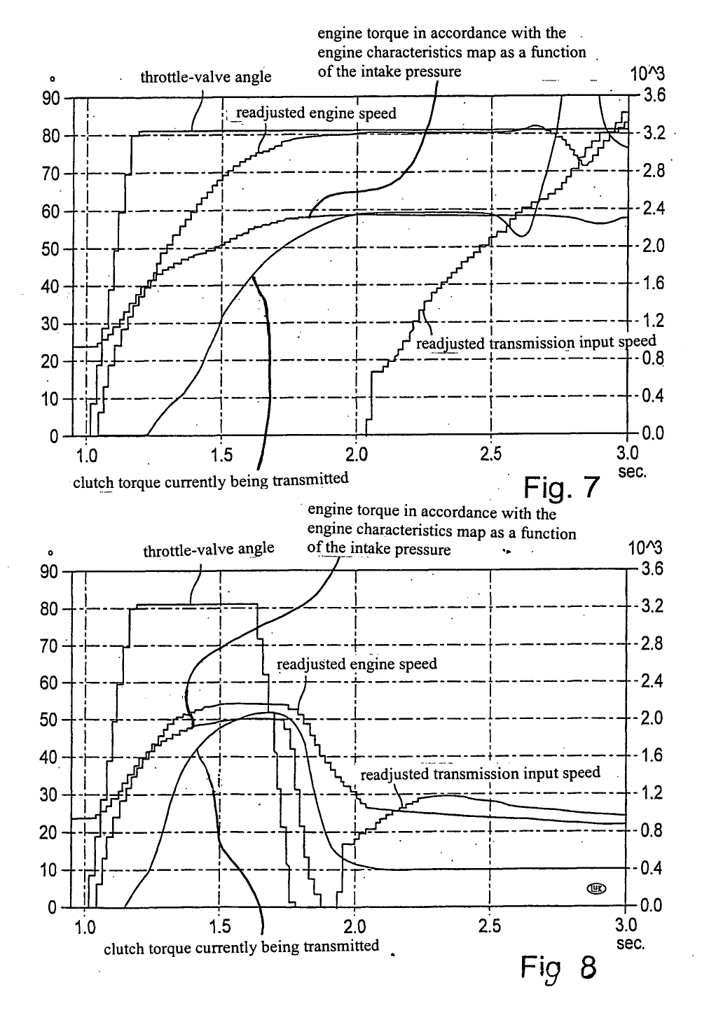

FIG. 8 a possible driveaway strategy in a back-out operating state;

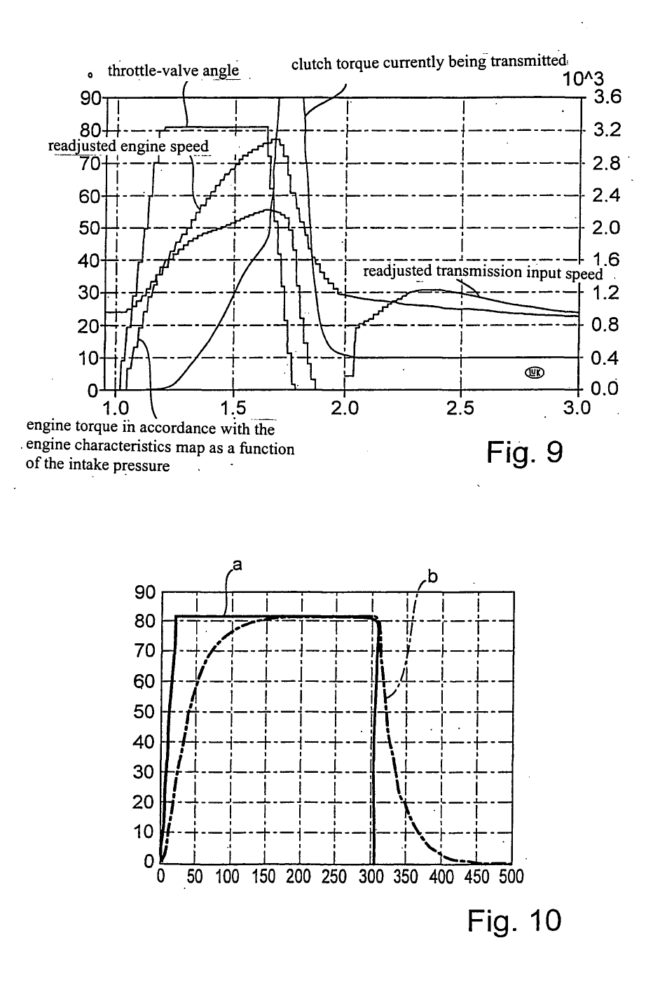

FIG. 9 an improved driveaway strategy in a back-out operating state in accordance with FIG. 8;

FIG. 10 a signal characteristic filtered by an exponential timing element;

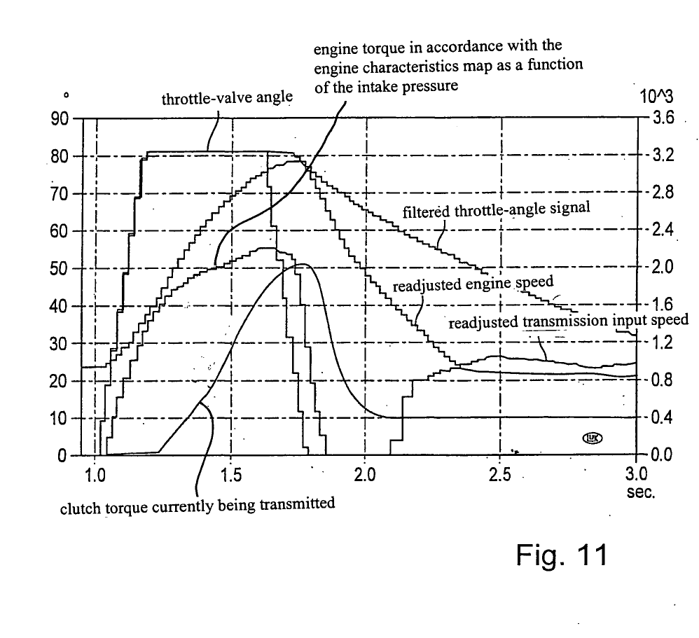

FIG. 11 filtered signal characteristics having a time constant of 170;

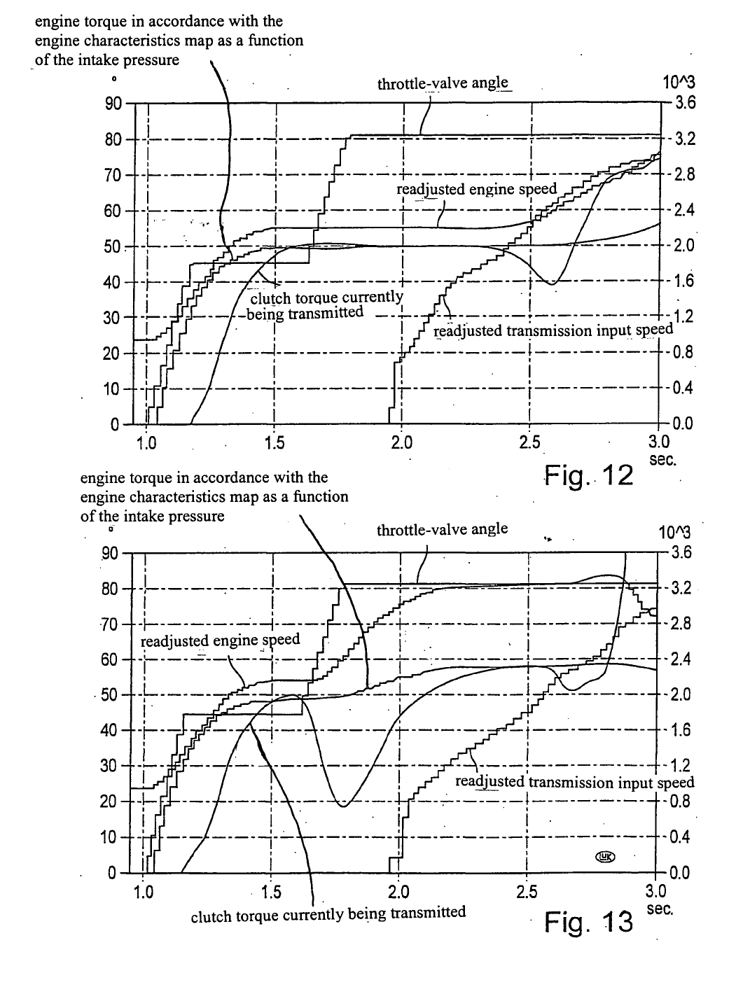

FIG. 12 a possible driveaway strategy in a tip-in operating state;

FIG. 13 an improved driveaway strategy in a tip-in operating state in accordance with FIG. 12;

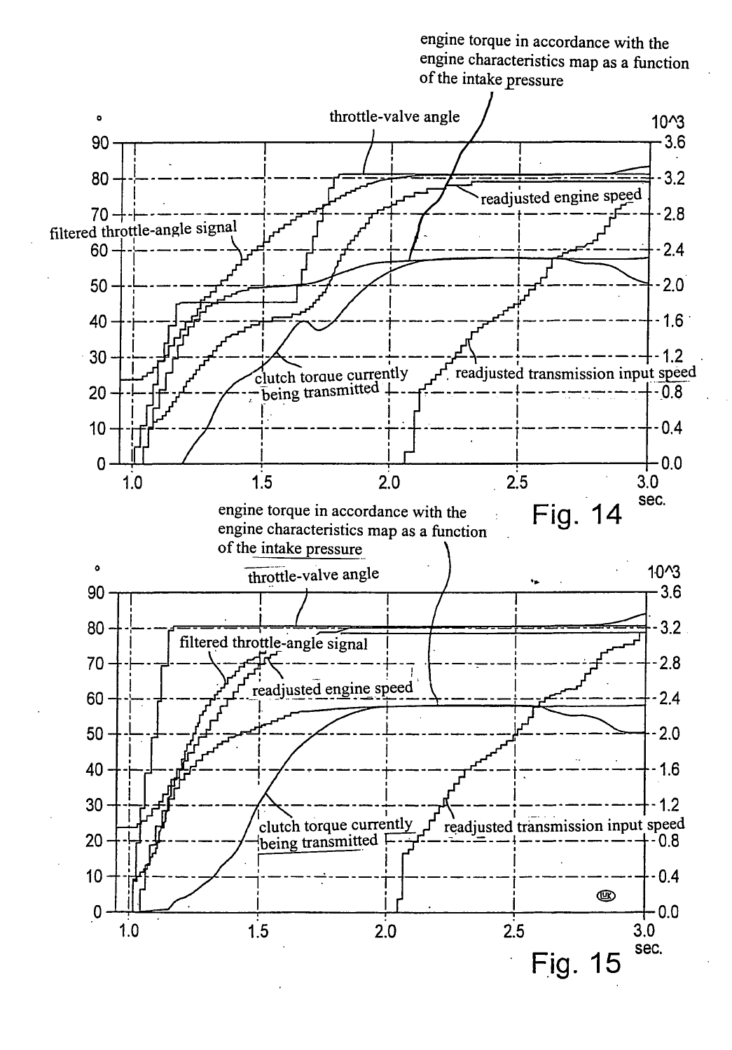

FIG. 14 filtered signal characteristics having a time constant of 17;

FIG. 15 a full-load driveaway operation using a driveaway strategy in accordance with FIG. 7;

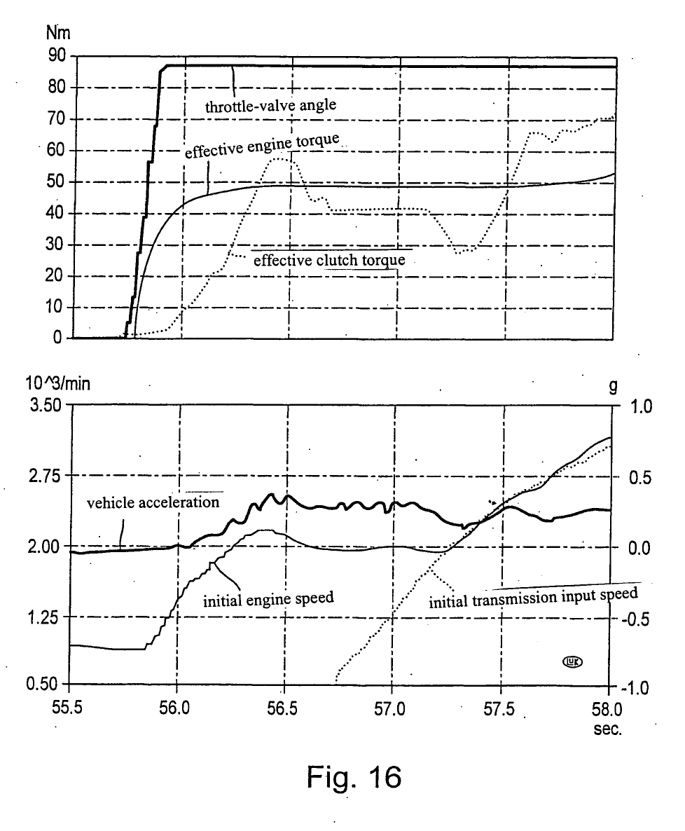

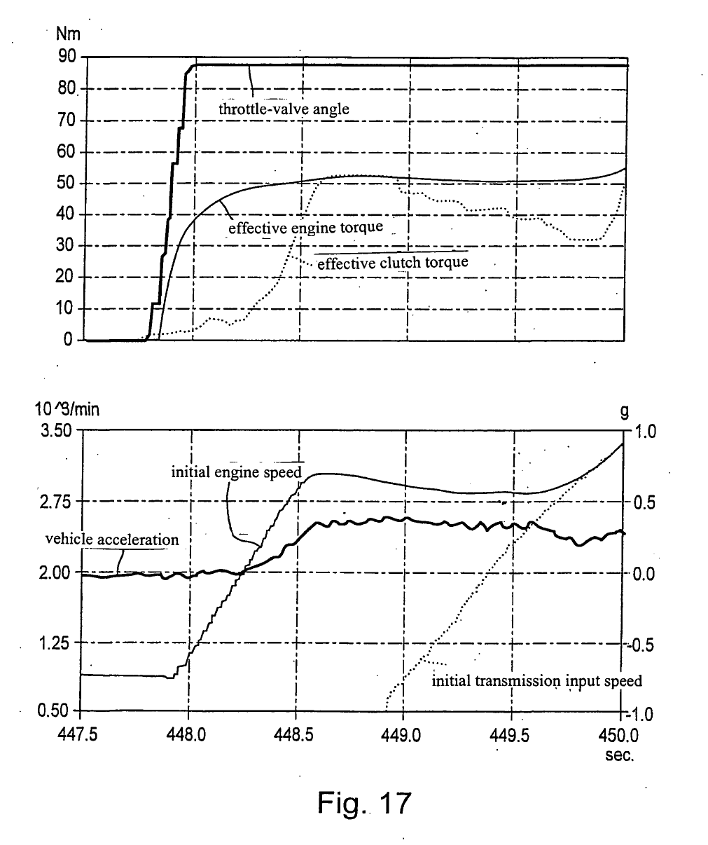

FIG. 16 another possible full-load driveaway operation;

FIG. 17 another possible full-load driveaway operation;

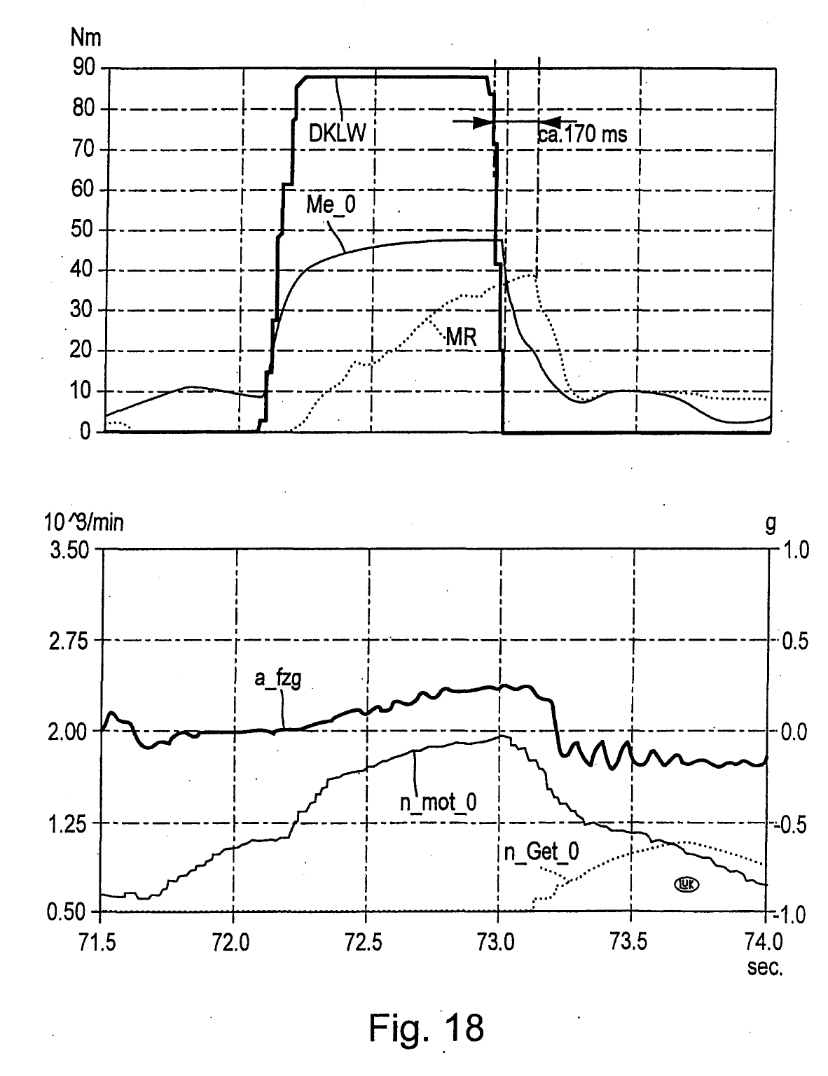

FIG. 18 an original driveaway operation in a back-out operating state;

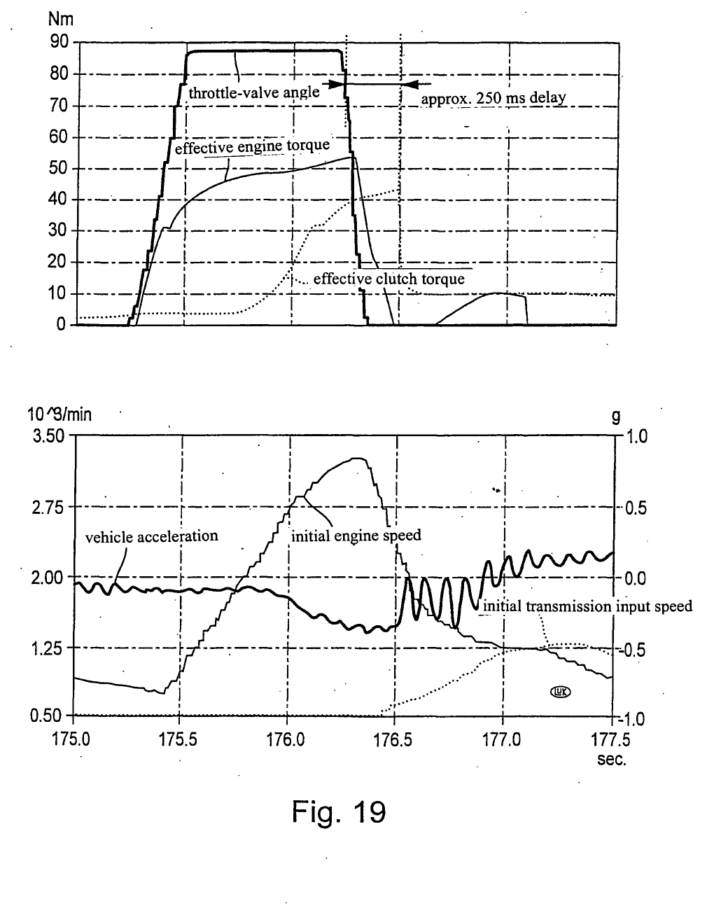

FIG. 19 a driveaway operation according to the present invention in a back-out operating state;

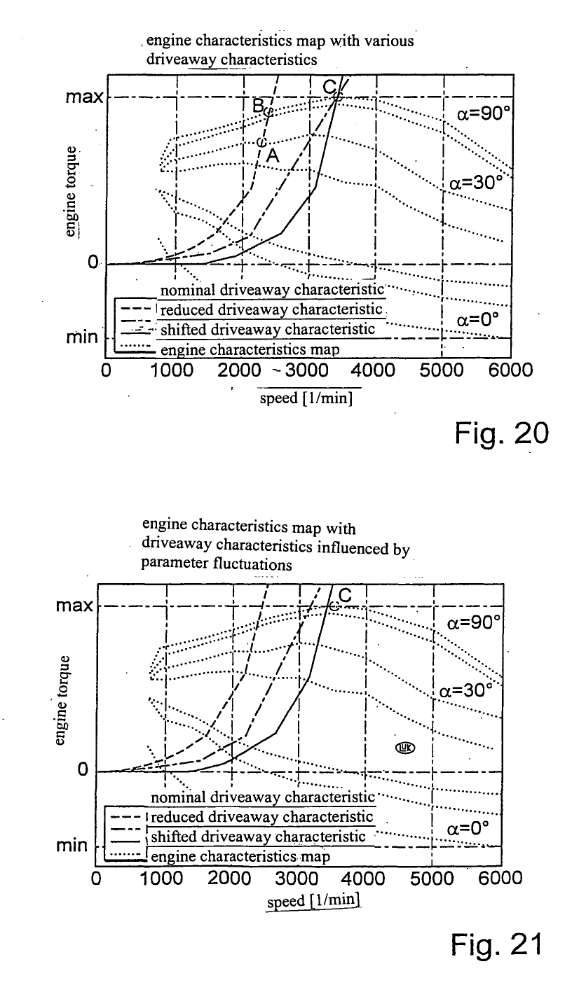

FIG. 20 an engine characteristics map of a vehicle, and driveaway characteristic curves;

FIG. 21 an engine characteristics map of a vehicle and driveaway characteristic curves having changed parameters;

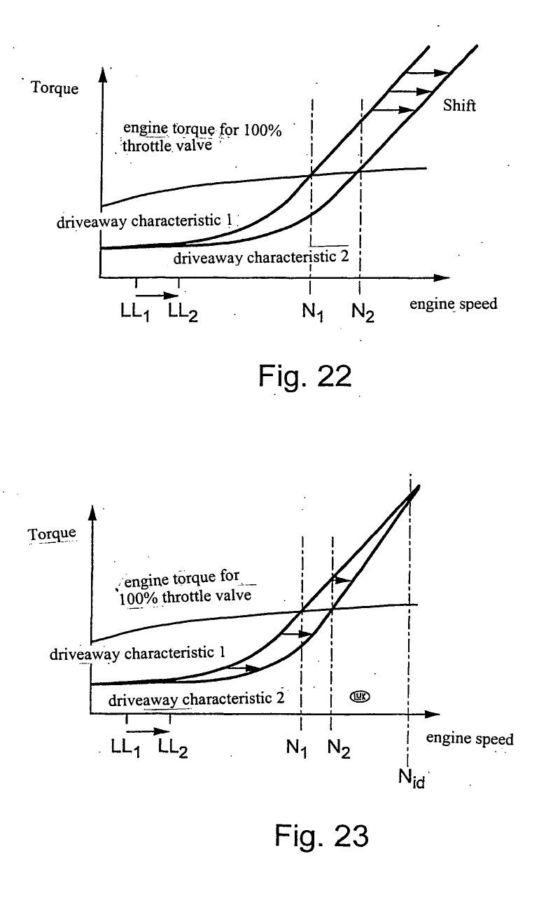

FIG. 22 a driveaway characteristic curve having a normal idling speed and a driveaway characteristic curve having an elevated idling speed; and

FIG. 23 two driveaway characteristic curves whose curves are identical at engine speed N_{id}.

FIG. 1 shows a plurality of driveaway characteristic curves for various gears for setting a vehicle in motion. The driveaway characteristic curve for the first gear is illustrated by a curve marked with rhombi. A driveaway operation in reverse gear is indicated by a curve marked with rectangles. The driveaway characteristic curve for the second gear is illustrated by a curve marked with triangles. Finally, the driveaway characteristic curve having an increased factor is indicated by a curve marked with crosses.

In this manner, a so-called standard characteristic may preferably be used for the driveaway in first gear. A suitable weighting factor of, for example, 0.75 may be applied to this characteristic when in reverse gear, in order to be able to adjust lower clutch torques and ensure, in turn, a driveaway at higher engine speeds. This procedure may also be provided in a driveaway in second gear; a driveaway operation with an increased factor of, for example, 1.5 being enabled here. Thus, the driveaway characteristic curves illustrated in FIG. 1 are derived, the desired clutch torque being indicated in each instance as a function of the engine speed for various driveaway operations.

FIG. 2 schematically shows two driveaway characteristic curves as a function of time, a time-dependent driveaway characteristic curve being indicated for accelerator-pedal position 0 to 90° (rhombi), and the other characteristic for the kickdown position (rectangles) for a driveaway operation in first gear.

For the clutch torque, this has the effect that the value predefined by the characteristic is not immediately set at the clutch, rather the clutch torque is gradually approximated to the actual characteristic as a function of a suitable time value.

FIG. 3 schematically depicts a plurality of driveaway characteristic curves, where the desired clutch torque is indicated as a function of the engine speed and of the weighting factor. The curve marked with rhombi shows the driveaway characteristic curve in first gear after one second. The curve marked with rectangles shows the driveaway characteristic curve in first gear after 100 ms, and the curve marked with triangles shows the driveaway characteristic curve in first gear after 500 ms.

The clutch torque is dependent on the engine speed and the time factor, the time factor being additionally dependent on the accelerator-pedal position and/or the selected gear step. For the sake of simplicity, only the time dependency is shown in FIG. 3.

The time-dependent change in the driveaway characteristic curve allows a driveaway operation to be adapted to predefined driving situations. For example, a driveaway may be undertaken in maneuvering operation at a low load and a low engine speed. In the process, the driver may be slow to actuate the accelerator pedal, for example, in order to move the vehicle in maneuvering operation. In this case, he/she reaches the full desired clutch torque after just one second, i.e., as a function of the characteristic, he/she is able to adjust a driveaway speed that is only slightly above the idling speed.

When the driver desires a driveaway operation, for example in the middle or high load ranges, he/she will adjust the accelerator-pedal position to this effect more quickly. Since in the first second, however, the clutch is not yet adjusted to the maximum torque corresponding to the characteristic, the engine is able to run up relatively freely to its driveaway speed, to be limited at that point by the clutch torque that is building up. In this special driveaway operation, the above described measure makes for a distinctly smoother driveaway process, particularly once the torques are raised in the low speed range.

Different driveaway characteristic curves are schematically shown in FIG. 4. The driveaway characteristic curves indicated include an original driveaway characteristic curve (rhombi), a driveaway characteristic curve multiplied by a factor (0.277)(rectangles), and, in addition, the curve of the engine torque during a full-load driveaway (triangles).

From this it is apparent, that for a predefined vehicle, an engine torque of over 58 Nm is reached at 3000 rpm. A better driveaway characteristic curve may be attained when the clutch torque likewise assumes this value at 3000 rpm. This may be achieved, for example, in that the driveaway characteristic curve is shifted downwards, as indicated by the curve marked with rectangles. This transformation or shift is rendered possible by the factor of 0.277. In a standard driveaway strategy, a clutch torque of 204.65 Nm is reached, for instance, at a speed of 3000 rpm.

Using the method according to the present invention, it is possible to determine when the factor should be used and how high the factor should be selected. In the process, it is important that the driveaway characteristic curve be suitably adapted in the case of small throttle-valve angles as well, to ensure that the modulation of the driveaway characteristic curve is not degraded in this range. Accordingly, up to a throttle-valve angle of 45°, the factor may assume the value 1, for instance, to realize the desired driveaway characteristic curve. For full-load driveaway processes, on the other hand, the factor should be at 0.277, for instance. This value may also be used when the throttle-valve angle is larger than 70°. When the values of the throttle-valve angle are between 45° and 70°, the factor may be determined, for example, by a linear interpolation. Other values for the factor are also possible.

The values for the factor are schematically illustrated in FIG. 5 for a predefined vehicle. In this context, the value of the factor is shown over the throttle-valve angle. From this, a relationship is derived between the throttle-valve angle and the factor by which the driveaway characteristic curve is multiplied.

It turns out that the manner in which the factor is defined is comparable to the method used by the standard software with respect to the three following aspects:
1. full-load driveaway
2. back-out during the driveaway
3. tip-in during the driveaway

In FIGS. 6 through 9 and 11 through 19, the illustrated curves are designated by the following abbreviations, where
DKLW=the throttle-valve angle;
MR_IST=the clutch torque currently being transmitted;
MM_ANSAUG=the engine torque in accordance with the engine characteristics map as a function of the intake pressure;
n_MOT_neu=the readjusted engine speed;
n_GET_neu=the readjusted transmission input speed;
DKLW_FILT=the filtered throttle-angle signal;
Me_0=the effective engine torque;
MR=the effective clutch torque;
n_mot_0=the initial engine speed;
n_Get_0=the initial transmission input speed; and
a_fzg=the vehicle acceleration.

With respect to FIGS. 6 and 7, a considerable distinction may be ascertained between the different driveaway strategies. In FIG. 6, a full-load driveaway is simulated using a software, in which the driveaway strategy is not multiplied by a factor. In FIG. 7, on the other hand, a full-load driveaway is simulated, in which a suitable factor is considered.

The values of engine speed (n_MOT_neu), of engine torque (MM_ANSAUG) and of clutch torque (MR_IST) attain, at the same time (one second after driveaway begins), better values than in the driveaway strategy in accordance with FIG. 6. In the method of the present invention according to FIG. 7, a vehicle may reach 17 km/h in the shortest time, which corresponds approximately to a speed of 3000 rpm at the transmission input shaft (n_GET_neu) and forms a reference parameter between the strategies. The following tables illustrate and compare the values of the two different driveaway strategies after one second, during a full-load driveaway process.

Driveaway strategy in accordance with FIG. 6:

| | |
|---|---|
| engine speed | 2100/min |
| engine torque | 50 Nm |
| clutch torque | 50 Nm |
| time until reaching 17 km/h | 1.94 s |
| energy consumption | 9.1 kJ |

Driveaway strategy in accordance with FIG. 7:

| | |
|---|---|
| engine speed | 3224/min |
| engine torque | 58 Nm |
| clutch torque | 57 Nm |
| time until reaching 17 km/h | 1.80 s |
| energy consumption | 17.1 kJ |

Differences between the two driveaway strategies:

| | |
|---|---|
| engine speed | 53% higher |
| engine torque | 15% higher |
| clutch torque | 16% higher |
| time until reaching 17 km/h | 8% less |

The power input during a full-load driveaway operation may be used as the most important aspect when simulating various driveaway operations. In the driveaway strategy according to FIG. 7, a higher power input may be ascertained in full-load driveaway operations, while in the driveaway strategy according to FIG. 6, a high power input takes place in all types of driveaway operations, so that a calibration should additionally be undertaken in order to reach the maximum engine torque.

FIG. 5 schematically shows the relationship between throttle-valve angle (DKLW) and the factor. In the range of 45° to 70° of the throttle-valve angle, the clutch torque is reduced because the driveaway characteristic curve falls off in coincidence with the factor equaling 0.277, when a positive value of the gradient of the throttle valve exists. When the throttle-valve gradient on the other side has a negative value in the same interval, the driveaway characteristic curve returns to its original position, and the clutch torque builds up again. This increase is especially pronounced in driveaway operations in which a predefined vehicle reaches an engine speed greater than 1600 rpm. From this engine speed on, the driveaway characteristic curve has a steeper gradient, and the variation in the torque is consequently more pronounced, as also indicated in FIG. 4.

During a so-called back-out, the driveaway characteristic curve changes, the engine speed remaining more or less the same. Thus, the clutch-torque curve has a steep and more or less constant slope. This can mean a dangerous situation for the driver, because the vehicle moves forward suddenly when the driver interrupts the driveaway operation. Thus, a so-called back-out during a full-load driveaway operation is the most difficult case for a driveaway strategy, because there is a substantial variation in the throttle-valve values, so that a high engine speed exists.

FIG. 8 schematically depicts such a situation where one possible driveway strategy is applied. On the other hand, FIG. 9 shows the same situation where an improved driveaway strategy is applied (in accordance with FIG. 7).

When the increase in torque is caused by a change in the throttle-valve angle, provision may be made for a delay in this signal, for example. In this manner, if a full-load driveaway operation is stopped, the value of the throttle valve may be delayed correspondingly, until the engine speed reaches a safe value, e.g., when the clutch-torque curve changes and the torque builds up significantly.

It is also possible for the throttle-valve signal to be suitably filtered. For example, at least one so-called first-order PT-1 filter may be used. Other filters may also be used. The filter may suitably attenuate the throttle-valve signal in order to lessen the torque variation, particularly when the engine speed falls off. A suitable timing element for the filter (PT-1) may satisfy the following differential equation:

$$y = ( n + 1 ) = \frac{consty ( n ) + u ( n )}{const + 1}$$

where
u(n)=the throttle-valve signal
y(n)=the filtered throttle-valve signal
constant=time constant of the filter.

A suitable transfer finction is illustrated in the following:

$$y ( s ) = \frac{1}{τ s + 1}$$

FIG. 10 illustrates an exponential action of the filter, for example, the delay in the response between input signal (a) and output signal (b) being indicated. In this context, a suitable step signal is shown for a predetermined time which is suited for illustrating the throttle-valve value as a signal. This illustration is expressed by the following equation:

$$y ( t ) = 1 - e \frac{- t}{τ}$$

When the throttle-valve factor is invariably at 0.277 in the interval from 70° to 90°, the PT-1 filter may be used with a constant having the value of about 170. It has been shown that this value is advantageous for the constant. Other values may also be used for the time constant. The delay in the filtered throttle-valve value renders possible a constant, smooth characteristic curve in an interval from about 45° to 70°, the increase in the clutch torque being delayed, while the engine speed drops.

A substantial variation in the throttle-valve value may be ascertained at highest speeds, during a so-called back-out in a full-load driveaway situation. Moreover, it could be ascertained that this situation may be suitably analyzed by a filter, as also indicated in FIG. 11.

When the time constant of the filter is greater than 170, it may be ensured that the clutch torque does not rise during a so-called back-out. This may also be inferred from FIG. 11, filtered throttle-valve signal (DKLW_FILT), as also clutch torque (MR_IST) likewise no longer increasing.

It is also possible to use a filter during a so-called tip-in. The clutch torque falls during the tip-in when the throttle-valve angle rises in an interval of about 45° to 70°. The two described driveaway strategies are shown in FIGS. 12 and 13, respectively, during a tip-in.

As is also the case in a back-out, different time constants may be used during a tip-in. It is possible for different time constants to be provided during a positive and a negative value of the throttle-valve gradient.

It has been shown that, given a positive value of the throttle-valve gradient, the time constant of the filter may assume value 17, for instance, to ensure a continuous and smoothest possible transition of throttle-valve angle (DKLW_FILT) at values of between 45 and 700°. This may also be inferred from the curves in FIG. 14.

In this context, the reduction in clutch torque (MR_IST) is insignificant.

During a negative gradient, the time constant of the filter may be set to value 170 for all throttle-valve values, and, during positive gradients, the time constant may assume value 17. Other values for the time constant of the filter are also possible.

In FIG. 15, the full-load driveaway operation is simulated using the driveaway strategy in accordance with FIG. 7, the following being the relevant data:
engine speed 3224 rpm
engine torque=58.3 nm
clutch torque=57.9 nm
time until reaching 17 km/h=1.89 seconds
energy consumption 16.6 kJ

By comparing the results of the two driveaway strategies, it may be ascertained that:
Engine speed (n_MOT_neu), clutch torque (MR-IST) and engine torque (MM_ANSAUG) become as high as when working with the driveaway strategy according to FIG. 7.
The time until reaching 17 km/h lies between the times of the two driveaway strategies.
The energy consumption during the driveaway operation is 2.57% less than in the driveaway strategy where the factor is used.

The full-load driveaway operations in accordance with the two described driveaway strategies are shown in FIGS. 16 and 17. The relevant aspects are as follows:

In the stationary state, the engine speed (using the second driveaway strategy (FIG. 7)) is 3037 rpm, whereas it is 2172 rpm using the first driveaway strategy. This is an increase of over 40%. Using the second driveaway strategy, 20 km/h is reached in a time that is faster by 0.25 seconds. In the second driveaway strategy, the power input is 87% higher. The ride comfort during the driveaway process is not reduced, vehicle acceleration (a_fzg) being used as a reference parameter.

By modifying the curve of the throttle-valve factor, it is possible to reduce the power input, however the driveaway speed may be adversely affected in the process. This relation may be improved by a suitable calibration.

With respect to the back-out operating state in FIGS. 18 and 19, it is ascertainable that the smooth rise in the torque no longer exists. The driveaway operation may be suitably influenced by introducing a factor which is dependent on the throttle-valve value (FIG. 19). The engine speed and the torque are substantially increased during the driveaway operation, in the same way as also the power input at the clutch. Moreover, it has been shown that by using the driveaway strategies provided by the method of the present invention, the time needed for the vehicle to reach the speed of 20 km/h is reduced. This is apparent from a comparison of FIGS. 18 and 19. The time may be reduced from 250 ms (FIG. 18) to 170 ms (FIG. 19).

Problems possibly arising during a tip-in and a back-out, may be advantageously avoided by using a filter. The filter may be a so-called first-order PT-1 filter, for example, having different time constants given positive and negative values of the gradient of the throttle-valve angle. In this way, variations in the curve of the throttle-valve angle may be changed. For example, an improved calibration may be undertaken. Other measures are also possible to further optimize, on the whole, the driveaway strategy according to the present invention.

The driveaway operation of a vehicle may be carried out, for example, using a nominal driveaway characteristic curve, as shown in FIG. 20. An engine characteristics map and various driveaway characteristic curves having nominal parameters are schematically indicated in FIG. 20. It turns out, however, that the driveaway speed, i.e., the engine speed during a driveaway operation, is set to be quasi steady-state and only changes slightly since the engine torque at larger throttle-valve angles (α) also only changes to a slight degree. A change in the throttle-valve angle from 30° (part-load driveaway, see point A) to 90° (full-load driveaway, see point B) only slightly influences the driveaway speed, which is defined by the intersecting points of the driveaway characteristic curve with the lines of the engine characteristics map corresponding to the various throttle-valve angles.

To consider the driver input to a greater degree, it may, therefore, be provided for the driveaway speed to change as a function of the accelerator pedal or throttle-valve angle. It is possible for this effect to be achieved in that a flatter characteristic is provided, as sketched in FIG. 20, for example, as a reduced driveaway characteristic curve (see point C for a full-load driveaway). A flattening off or reduction in the characteristic curve may also be fundamentally achieved by a throttle-valve angle-dependent factor.

However, the system is more sensitive to parameter fluctuations when a flattened characteristic is used. Parameter fluctuations of this kind may occur both at the engine, e.g., due to altitude above sea level, as well as at the clutch, for example due to a coefficient of friction that changes under the influence of temperature. This is clarified in FIG. 21, in that the engine characteristic and driveaway characteristic curve are scaled relatively to one another by 30%. The new intersecting point of the flattened driveaway characteristic curve shifts toward point C of the nominal state by about 400 rpm, i.e., the parameter changes have a considerable effect on the driveaway function.

In accordance with the present invention, clutch torque Mₖ may be determined by the following function:
Mₖ=driveaway characteristic curve (n_{engine}-k_{α}α)
M_{K} being=desired clutch torque
n_{engine}=engine speed
k_{α}·α=correction term and
αbeing=accelerator-pedal angle/throttle-valve angle.
The function of the driveaway characteristic curve, which is represented by the right side of the above equation, may be ascertained here by evaluating the nominal driveaway characteristic curve, preferably by using interpolation.

Accordingly, it may be provided for the argument of the characteristic evaluation to be corrected using accelerator pedal-dependent term K_{α}·α. In this context, factor K_{α}preferably relates to a constant value, which may be selected, for example, to equal 10. Other values for factor K_{α}are also possible.

Under this condition, given a full-load driveaway (α=90°), an increase in the driveaway speed by about 900 rpm is achieved in comparison to point B (from the conventional driveaway function). This relation is indicated in FIG. 20 by the shifted driveaway characteristic curve.

To realize the above-mentioned measures in the vehicle, it is possible for a rate-of-change limitation to be provided for correction term K_{α}·α, in order to avoid an undesired clutch torque curve, for example in response to rapid accelerator pedal changes during the driveaway process. Other suitable measures are also possible here, in order to optimize the driveaway process of the vehicle.

It is especially beneficial that when a driveaway function is applied using an appropriate correction term, the entire system is substantially less sensitive to parameter fluctuations. This is apparent, in particular, from FIG. 21. Since the slope angle of the shifted characteristic is clearly steeper than the flattened or reduced characteristic, the changed parameter conditions only have a negligible effect. This is because the ensuing driveaway speed deviates from the nominal case (FIG. 20 or point C) by only about 100 rpm, while a deviation of approximately 400 rpm is possible when working with a flattened characteristic.

Two driveaway characteristic curves 1 and 2 are schematically shown in FIG. 22. Driveaway characteristic curve 1 represents a characteristic for a normal idling speed, i.e., the engine is in a warm state. In this context, given the assumed curve of the engine torque, driveaway speed Ni is derived, as shown in FIG. 22.

In addition, in FIG. 22, driveaway characteristic curve 2 is schematically shown, this characteristic being characterized by a high idling speed, i.e., the engine is in a cold state. The characteristic is shifted on the speed axis by the difference between the idling speed of a cold and warm engine, toward higher speeds. From this, the characteristic curve of driveaway speed N2 is derived. It should be noted in this context that, when the idling speed increases by 400 rpm, the driveaway speed likewise shifts by 400 rpm.

It turns out that it is advantageous when the driveaway characteristic curve is merely shifted in stages, for example. This may be accomplished, for example, in that the characteristic is shifted by the difference between warm idling speed LLᵢ, and current idling speed LL₂, e.g., toward higher speeds, when, for example, the engine speed equals the current idling speed. Other possibilities are also conceivable for suitably shifting the driveaway characteristic curve in stages.

However, with increasing engine speed, the shift may decrease linearly until it reaches the value zero at engine speed N_{id}. In this procedure, the difference in the driveaway speed becomes all the less, the higher the driveaway speed is. As a result, the performance characteristics become advantageously more similar for a cold or warm engine. For speeds higher than engine speed N_{id}, the characteristics may be identical for elevated and normal idling speeds.

A shift of this kind in the driveaway characteristic curve is schematically shown in FIG. 23. It becomes clear that the lower engine speed N_{id} is selected, the less of an effect the shift has on the driveaway speed. Preferably, engine speed N_{id} should not be selected to be arbitrarily low, since as the driveaway characteristic curve partially shifts, in response to increasing idling speed, the slope of the driveaway characteristic curve changes correspondingly, thereby possibly affecting the ride comfort. For instance, for engine speed N_{id}, the value of 3000 rpm may be selected. Other values may be selected, as needed, for this engine speed.

The claims filed with the application are proposed formulations and do not prejudice the attainment of further patent protection. The applicant reserves the right to claim still other combinations of features that, so far, have only been disclosed in the specification and/or the drawings.

The antecedents used in the dependent claims refer, by the features of the respective dependent claim, to a further embodiment of the subject matter of the main claim; they are not to be understood as renouncing attainment of an independent protection of subject matter for the combinations of features of the dependent claims having the main claim as antecedent reference.

Since, in view of the related art on the priority date, the subject matters of the dependent claims may form separate and independent inventions, the applicant reserves the right to make them the subject matter of independent claims or of divisional applications. In addition, they may also include independent inventions, whose creation is independent of the subject matters of the preceding dependent claims.

The exemplary embodiments are not to be understood as limiting the scope of the invention. Rather, within the framework of the present disclosure, numerous revisions and modifications are possible, in particular such variants, elements and combinations and/or materials, which, for example, by combining or altering individual features or elements or method steps described in connection with the general description and specific embodiments, as well as the claims, and contained in the drawings, may be inferred by one skilled in the art with regard to achieving the objective, and lead, through combinable features, to a new subject matter or to new method steps or sequences of method steps, also to the extent that they relate to manufacturing, testing, and operating methods.

1-35 (canceled)

36. A method for controlling a vehicle transmission, comprising:
modifying a driveaway characteristic curve based on different operating conditions of the vehicle so as to take into account a driver input during a driveaway of the vehicle; and
adjusting a desired clutch torque using the driveaway characteristic curve.

37. The method as recited in claim 36, wherein the vehicle transmission includes at least one of an automated shift transmission and an automatically operated clutch.

38. The method as recited in claim 36, wherein the modifying of the driveaway characteristic curve is performed using a suitable factor.

39. The method as recited in claim 38, wherein the suitable factor is weighted as a function of at least one of an accelerator pedal and a gear of the vehicle.

40. The method as recited in claim 38, wherein the suitable factor is changed using a time function.

41. The method as recited in claim 40, wherein the time function includes a linear function having a predefined slope.

42. The method as recited in claim 40, wherein the suitable factor is changed according to a time ramp during a transition from a normal driving condition to a kickdown operating condition of the vehicle.

43. The method as recited in claim 38, wherein a temperature of the clutch is considered as a parameter for determining the suitable factor.

44. The method as recited in claim 36, wherein the modifying of the driveaway characteristic curve is performed as a function of a factor, the factor being dependent at least on a signal of the vehicle, wherein the signal includes at least one of a throttle valve-angle signal and an accelerator pedal-angle signal.

45. The method as recited in claim 44, further comprising filtering the signal using at least one suitable filter so as to prevent a substantial fluctuation in an engine torque in response to rapid changes in at least one of the throttle-valve angle and the accelerator-pedal angle.

46. The method as recited in claim 45, wherein the at least one suitable filter includes two filters, each of the two filters having different timing elements.

47. The method as recited in claim 45, wherein the at least one suitable filter includes a first-order PT-1 filter.

48. The method as recited in claim 45, wherein the at least one suitable filter includes an exponential timing element.

49. The method as recited in claim 45, wherein the at least one suitable filter includes a plurality of different timing elements.

50. The method as recited in claim 44, wherein the factor includes a gradient of a throttle valve-dependent factor.

51. The method as recited in claim 50, wherein the gradient is limited by a predefined limiting value.

52. The method as recited in claim 44, wherein the modifying of the driveaway characteristic curve by the factor at least at one predetermined section of the curve.

53. The method as recited in claim 44, wherein the modifying of the driveaway characteristic curve is performed using the factor according to an operating state of the vehicle.

54. The method as recited in claim 53, wherein the operating state includes at least one of a full-load driveaway, a back-out during the driveaway operation, and a tip-in during the driveaway operation.

55. The method as recited in claim 36, wherein the clutch torque (M_{K}) is calculated in accordance with the following finction:
Mₖ=driveaway characteristic curve (n_{engine}- k_{α}·α); wherein:
M_{K}=desired clutch torque
n_{engine}=engine speed
k_{α}·α=correction term
α=one of the accelerator-pedal angle and the throttle-valve angle.

56. The method as recited in claim 55, wherein the modifying of the driveaway characteristic curve using a correction term according to different operating conditions of the vehicle.

57. The method as recited in claim 56, wherein the correction term includes a rate-of-change limitation so as to avoid undesired clutch torque curves.

58. The method as recited in claim 55, further comprising increasing a driveaway engine speed of the vehicle by about 900 rpm, during a full-load driveaway operation.

59. The method as recited in claim 56, wherein the modifying of the driveaway characteristic curve includes suitably shifting the driveaway characteristic curve by the correction term.

60. The method as recited in claim 36, wherein the modifying of the driveaway characteristic curve includes shifting the driveaway characteristic curve, at least in stages, as a function of a current engine speed of the vehicle.

61. The method as recited in claim 60, wherein the shifting includes shifting the driveaway characteristic curve toward higher speeds when the current engine speed is approximately equal to a current idling speed.

62. The method as recited in claim 60, wherein the shifting includes shifting the driveaway characteristic curve toward higher engine speeds by a difference between an idling speed (LL₁) typical of a warm engine, and a current idling speed (LL₂).

63. The method as recited in claim 60, wherein the shift in the driveaway characteristic curve decreases linearly with increasing engine speed, until the shift reaches a preset engine speed (N_{id}).

64. The method as recited in claim 63, wherein the driveaway characteristic curve is identical for elevated idling speeds and for normal idling speeds within a range of engine speeds that are higher than a preset engine speed (N_{id}).

65. The method as recited in claim 36, further comprising driving the clutch using a closing function in predefined operating states of the vehicle.

66. The method as recited in claim 65, wherein the closing function is not activated when engaging a reverse gear of the vehicle.

67. The method as recited in claim 65, wherein the closing function is only used in a reverse gear above a predefined temperature threshold.

68. The method as recited in claim 65, wherein the closing function is inhibited during a preset number of driveaway situations during a driving cycle.

69. The method as recited in claim 68, further comprising:
initializing a counter is initialized at a beginning of a driving cycle to a value 0 when it is recognized in a driveaway situation that a clutch slip after a predefined time period has still not yet been reduced;
incrementing the counter at every driveaway operation of the vehicle where continuous slip is recognized, wherein the incrementing is performed by one of increasing the counter by standard increment and increasing the counter proportionally to a time duration of the clutch slip.
keeping the closing function inactive when the counter has not yet exceeded a predefined counter reading; and
activating the closing function when the counter exceeds a predefined threshold.

70. The method as recited in claim 65, wherein the closing of the clutch is one of accelerated and carried out at an earlier point in time when a gradient of the clutch temperature exceeds a predefined value.

71. The method as recited in claim 70, further comprising determining the gradient of the clutch temperature, wherein the determining of the gradient of the clutch temperature includes determining a first temperature of the clutch during a predefined time interval and comparing the first temperature to a second temperature of the clutch determined during a previous time interval.
